(19) United States
(12) Patent Application Publication
(10) Pub. No.: US 2013/0226724 A1
(43) Pub. Date: Aug. 29, 2013

(54) METHODS AND SYSTEMS FOR PRICING COST OF EXECUTION OF A PROGRAM IN A PARALLEL PROCESSING ENVIRONMENT AND FOR AUCTIONING COMPUTING RESOURCES FOR EXECUTION OF PROGRAMS

(71) Applicants: Andrew C. FELCH, Palo Alto, CA (US); Thomas M. DOUGHERTY, New York, NY (US)

(72) Inventors: Andrew C. FELCH, Palo Alto, CA (US); Thomas M. DOUGHERTY, New York, NY (US)

(73) Assignee: COGNITIVE ELECTRONICS, INC., Lebanon, NH (US)

(21) Appl. No.: 13/594,148

(22) Filed: Aug. 24, 2012

Related U.S. Application Data
(60) Provisional application No. 61/528,077, filed on Aug. 26, 2011.

(51) Int. Cl. G06Q 30/08

(52) U.S. Cl. CPC G06Q 30/08
USPC 705/26.3

(57) ABSTRACT

An automated auction-based method of determining price to execute one or more candidate programs on a parallel computing system is disclosed. The parallel computing system includes a plurality of computing resources, each having a price per unit of time. For each candidate program, a plurality of executions are performed using different amounts of computing resources. The number of program outputs completed during each execution is measured. A plurality of bids defining a price for completing a desired number of program outputs in a desired amount of time are received. The amount of computing resources required to fulfill each bid is determined. A price per unit of time for the computing resources for each bid is calculated based on the price associated with the bid and the determined amount of computing resources required to fulfill the bids. The bids are fulfilled based on the calculated price per unit of time.

### CROSS-REFERENCE TO RELATED APPLICATIONS

This application claims priority to U.S. Provisional Patent Application No. 61/528,077 filed Aug. 26, 2011, which is incorporated herein by reference.

### BACKGROUND OF THE INVENTION

The ability to share computing resources among multiple applications and multiple users has become an important tool for many organizations. Parallel computing resources are well suited to this type of sharing. Users from various organizations access such shared computing resources over a network such as the Internet. One example of such shared resources is a Cloud computing environment. In a Cloud computing environment, a provider organization allows other organizations or users to use computing resources (processors, memory, servers, bandwidth and the like) for a fee. Cloud computing provides benefits such as allowing users on demand access to a larger amount of computing resources than they currently have, without the need to maintain those resources internally.

A common use of cloud computing systems is for parallel processing. Parallel processing involves the use of parallel programs and parallel hardware by taking a single program and dividing it into subtasks that can be processed simultaneously (in parallel). This approach contrasts with multiprocessing, where different programs are processed simultaneously.

One characteristic of parallel processing is that a program that can be parallel processed can be computed more quickly by making more parallel computing resources available to the program. Amdahl's law describes how much more quickly a given parallel program can be processed given the provision of more parallel computing resources to the program. Amdahl's law provides a relationship between the percentage of the program that is parallel (can be broken up into sub tasks that execute simultaneously) versus the percentage of the program that is serial (can not be broken up into sub tasks that execute simultaneously) and the increase in performance of the program as more parallel computing resources are provided. If P is the proportion of a program that can be made parallel (i.e. benefit from parallelization), and (1−P) is the proportion that cannot be parallelized (remains serial), then according to Amdahl's law, the maximum speedup that can be achieved by using N processors is: 1/((1−P)+P/N).

The capability that parallel computing provides to accelerate the computation of parallel programs by adding more parallel hardware to the task creates an opportunity to do that acceleration. However, it is a challenge for users to determine an efficient amount of computational resources to apply to the parallel program and to balance the cost of those computational resources against the benefit of accelerating the program. In principle, a parallel program can use as many computing resources as are made available to it. For example, some massively parallel programs, such as GOOGLE PAGE RANK and SETI AT HOME, use huge amounts of computing resources. In such cases, the tradeoff of computing resources with application performance can become significant.

Existing Cloud Computing providers, such as AMAZON and RACKSPACE, allow customers to purchase time units (e.g., hours) of computing time on their computing infrastructure for set prices. This pricing model aligns well with running serial programs since the task is simply to buy time on a computational resource with a single, fast, processor to execute the program. In serial programs, the most that can be gained in terms of performance from hardware is to run the program on the fastest single processor available. As the cost of individual processors has declined, the need to balance the cost of any processor versus the performance of the algorithm has also declined since in almost all cases, the faster processor is the best solution for the serial program.

In addition, pricing parallel computing resources suffers from the additional complication that there is a limited amount of such resources and multiple users might want to use the same resources at the same time. Parallel processing systems are able to manage the available resources unless and until the total amount of resources that the users want to use is more than the amount of resources available in the parallel processing system. If there are insufficient resources to run all requested programs such that they deliver the desired output in the desired amount of time, it must be determined which of the requested programs, if any, will run.

Accordingly, it is desirable to allow users of such programs to bid for the right to run their programs to get a desired output or outputs in a desired amount of time on the computational resources. It is further desirable to determine which of the bids represents the highest profit for the provider based on resource availability and utilization.

### BRIEF SUMMARY OF THE INVENTION

In one embodiment, an automated auction-based method of determining price to execute one or more candidate programs on a parallel computing system is disclosed. The parallel computing system includes a plurality of computing resources, each of the computing resources having a price per unit of time. A plurality of executions of a candidate program are performed. Each execution is for a recorded amount of time and uses different amounts of the computing resources. The number of program outputs completed during each execution is measured; A plurality of bids are received for a plurality of the candidate programs. Each bid defines a price for completing a desired number of program outputs in a desired amount of time. The amount of computing resources required to fulfill each of the bids is determined based on the number of program outputs completed during each execution. A price per unit of time for the computing resources for each of the bids is calculated based on the price associated with the bid and the determined amount of computing resources required to fulfill each of the bids; The bids are fulfilled based on the calculated price per unit of time for the computing resources, from highest to lowest until the available amount of computing resources is exhausted.

An automated method of determining price to execute a candidate program on a parallel computing system is disclosed. The parallel computing system includes a plurality of computing resources. Each of the computing resources has a price per unit of time. A plurality of executions of a candidate program are performed. Each execution being for a recorded amount of time and using different amounts of the computing resources. The number of work units completed are measured during each execution. Pricing data for execution of the candidate program is defined based on (i) the measured number of work units completed during each execution, (ii) the price per unit of time, and (iii) the desired time to complete the desired number of work units, the pricing data defining prices for the parallel computing system to execute the candidate program to complete a desired number of work units in a desired amount of time.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 is a flowchart illustrating steps for pricing execution of a candidate program in a parallel processing system in accordance with one preferred embodiment of this invention;

FIG. 2 is a flowchart illustrating steps for analyzing a candidate program in accordance with one preferred embodiment of this invention;

FIG. 3 is a block diagram illustrating elements of the parallel computing resources in accordance with one preferred embodiment of this invention;

FIG. 4 is an overview of a parallel computing architecture;

FIG. 5 is an illustration of a program counter selector for use with the parallel computing architecture of FIG. 4;

FIG. 6 is a block diagram showing an example state of the architecture in FIG. 4;

FIG. 7 is a block diagram illustrating cycles of operation during which eight Virtual Processors execute the same program but starting at different points of execution;

FIG. 8 is a block diagram of a multi-core system-on-chip;

FIG. 9 shows the database of resources and time in accordance with one preferred embodiment of this invention;

FIG. 10A, shows a Program Output API database in accordance with one preferred embodiment of this invention;

FIG. 10B shows a Time and Computing Resources Used Database in accordance with one preferred embodiment of this invention;

FIG. 11A shows a Candidate Program Output Performance Database in accordance with one preferred embodiment of this invention;

FIG. 11B shows a Database of Computing Resource Prices Per Unit of Time in accordance with one preferred embodiment of this invention;

FIG. 12 shows the Database of Computing Resources Ratios in accordance with one preferred embodiment of this invention;

FIG. 13 shows a procedure for determining the price of computing resources required per candidate parallel program output in accordance with one preferred embodiment of this invention;

FIG. 14 shows a Database of Pricing Data for candidate programs output in accordance with one preferred embodiment of this invention;

FIG. 15 shows a flowchart for determining pricing for execution of a program based on the pricing data of FIG. 14 output in accordance with one preferred embodiment of this invention;

FIG. 16 is a block diagram illustrating competing bids for execution of two programs (A and B) on the processing system in accordance with one preferred embodiment of this invention;

FIG. 17 block diagram illustrating another example of competing bids for execution of two programs (A and B) on the processing system in accordance with one preferred embodiment of this invention;

FIG. 18 is a block diagram a block diagram showing a high level representation of the system for bidding for execution of programs in the parallel processing program in accordance with one preferred embodiment of the invention; and

FIG. 19 shows a flowchart for determining pricing for execution of a program based on the pricing data of FIG. 14 output in accordance with one preferred embodiment of this invention.

### DETAILED DESCRIPTION OF THE INVENTION

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

Referring to the drawings in detail, wherein like reference numerals indicate like elements throughout, systems and methods for pricing and auctioning access to and utilization of shared parallel computing systems are described. The system receives bids from users for execution of their programs, the bids defining the number of program outputs desired, the time desired to complete the computation of those program outputs and the price the user is willing to pay for the computation of the program outputs in the desired amount of time. The system compares the cost of running the program to generate the desired program outputs in the desired time with the price the user is willing to pay. The programs associated with the bids providing the highest profit margins are scheduled to execute until the capacity of the system is exhausted or there are no more programs to run. Thus, the program that provides the highest profit to the provider is scheduled to run first and then the programs that provide the next highest profit are scheduled to run in order until there are no more programs to run or the computing resources are utilized to the point that there is not enough capacity to run the next program in order.

Users seeking to utilize parallel hardware for executing parallel programs are typically concerned with three key variables. These variables are i) the number of program outputs required, ii) the time to compute those program outputs, iii) the price of the computational resources required to compute the outputs in the time allotted. These variables are related to one another. Thus, for example, where fewer program outputs are required, the time to compute those outputs and/or the number of computational resources required may be reduced.

An exemplary parallel program that plays chess demonstrates this dependency. The exemplary parallel program takes as an input the state of a chessboard and evaluates available moves for the players in order to select the best next move for one of the players. This is done by starting with a list of all possible moves, then simulating the progress of the game (or simulating the progress of the game up to a certain point) after making each of those moves. The program is a parallel program because each of these simulations can be run in parallel. The program scores the moves available to the player and outputs the move with the highest score.

In competitive chess, there is often a set amount of time allotted to each player to make a move, so the user of this program has an interest in having the analysis completed before the time to make a move is over. There can also be prizes awarded to winners of competitive chess games, so the user of such a program may have an interest in balancing the cost of the computing resources required to run the program versus the value of the prize if the game is won.

In this illustrative example, the user has a parallel chess playing program, knows the program output desired, the predicted best possible move, the time in which the program should be able to provide that output (the time allotted to a player to make a move), and would like to know the price of running the parallel program to generate the desired program output in the desired amount of time. This price may be determined using the embodiments of the invention described herein.

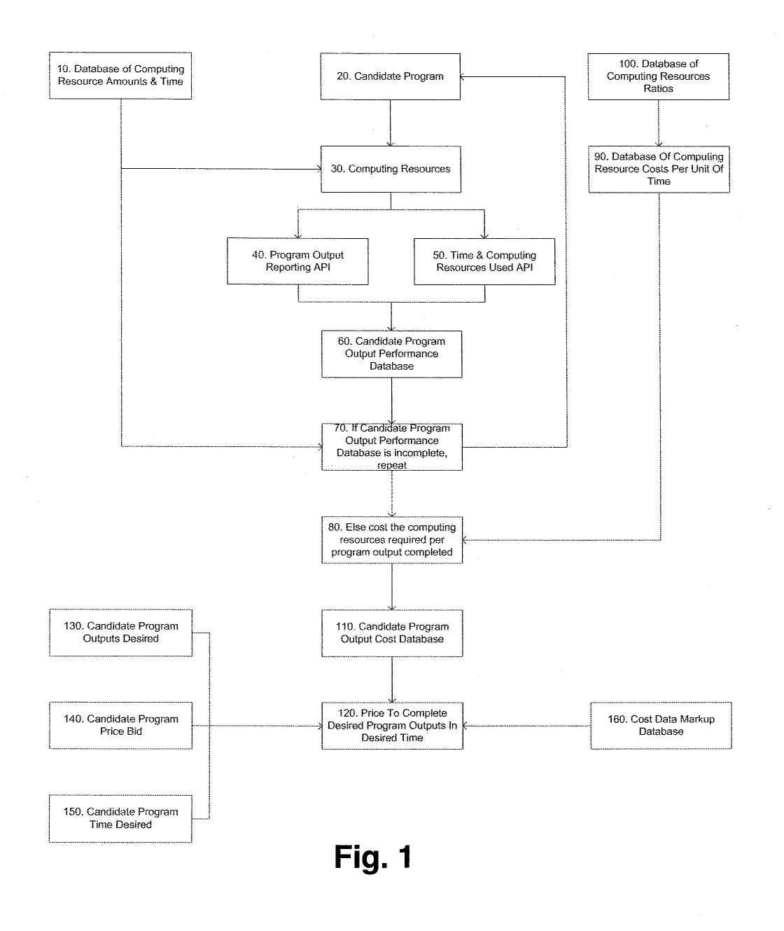

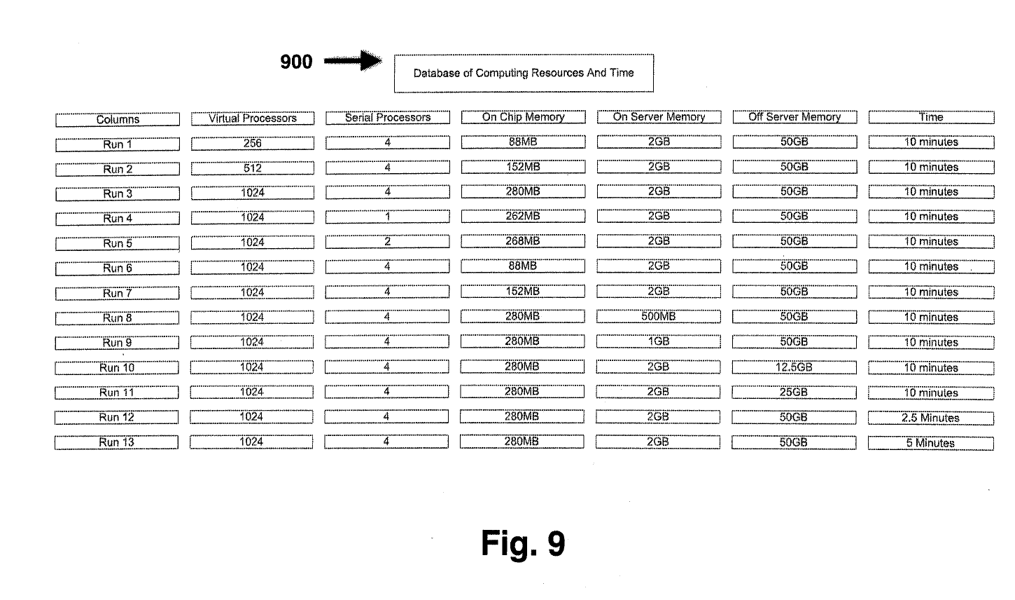

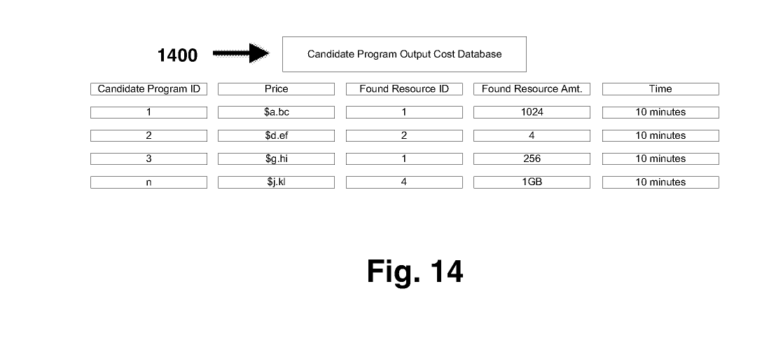

FIG. 1 is a flowchart illustrating steps for pricing execution of a candidate program in a parallel processing system. The pricing system allows the user to determine the price for generating the desired program output in the desired amount of time. The candidate program is run a plurality of times using a plurality of computing resources in order to build an Output Pricing Database 1400, as further described with reference to FIG. 14 below. The Output Pricing Database 1400 holds information about the relationship between computing resources used, time taken and outputs computed. The Database of Resources and Time 900, shown in FIG. 9, holds the time and computing resource amount information that will be used to run the candidate program in order to build this Output Pricing Database 1400.

Referring back to FIG. 1, in step 10, the computing resource amounts and time information is loaded from the Database of Resources and Time 900. A Candidate Program that the system is evaluating in order to determine pricing is loaded in step 20. Some or all of the Computing Resources may be used to run the candidate program. Which Computing Resources are used to run the program each particular time are specified by the information loaded in step 10.

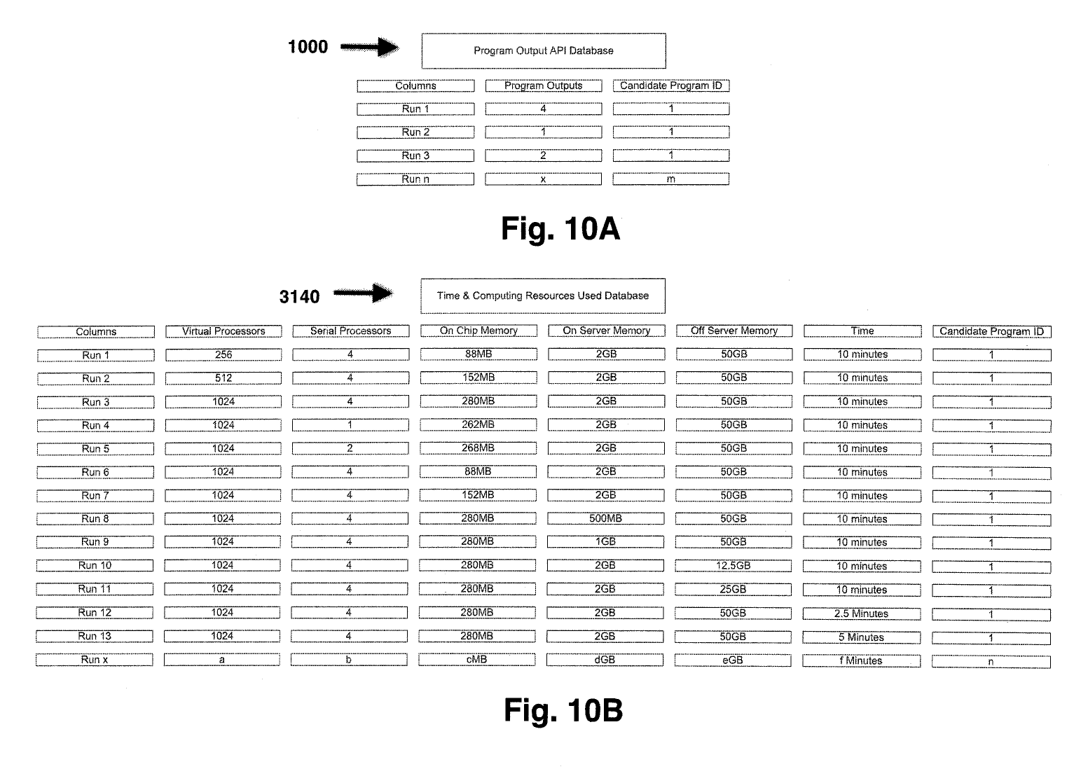

At step 40, the candidate program reports when it has finished computing a program output. The reported data is sent to the Program Output API Database 1000 (shown in FIG. 10A). In the case of the chess program, when the chess program has computed the best next move, it reports that the best next move computation has been completed.

In step 50, information about the amount of computing resources used during a run of the candidate program and the amount of time that these computing resources were used is provided to the Time & Computing Resources Used Database 1050 (shown in FIG. 10B). The reported information describes the relationship between the amount of computing resources used, the number of program outputs generated and the amount of time taken to generate those program outputs.

In step 70, an analysis module determines whether all of the prescribed runs of the candidate program specified in the Database of Resources and Time 900 have occurred. If they have not, the analysis module directs another run of the candidate program with the appropriate time and resource amount specified by the Database of Resources and Time 900 by returning to step 20.

At step 80, the price-setting module takes as an input the number of outputs that the candidate program generated and the resources and time allotted to create those outputs specified by the Database of Resources and Time 900. At step 90, information on the pricing of the computational resources is loaded from the Database of Computing Resource Prices Per Unit of Time 1150. At step 80, the price-setting module uses the information about the number of outputs generated and the information from step 90 to determine the price of the computing resources to compute an instance of the program output in a variable amount of time.

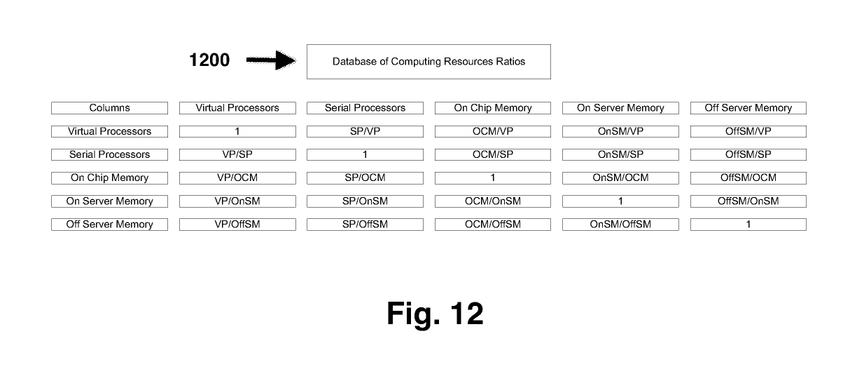

The Database of Computing Resource Prices Per Unit of Time 1150 stores prices for using each of the different computing resources for the variable amount of time. The Database of Computing Resources Ratios 1200 (shown in FIG. 12) contains the ratios of the amounts of the different computing resources available to each other. This information is loaded in step 100. At step 110, the Output Pricing Database 1400 (shown in FIG. 14) stores the pricing information generated by the price-setting module in step 80. At step 120, the pricing module takes as an input the pricing information stored in step 110, as well as two inputs selected from among Candidate Program Outputs Desired input 130, the Candidate Program Price Desired input 140 and the Candidate Program Time Desired input 150 and the pricing markup information loaded in step 160 to calculate and output a result. The result is variable based on the inputs provided. If the user provides a desired number of program outputs and a desired amount of time, the result will be a price. If the user provides a desired number of program outputs and a desired price, the result will be an amount of time to complete the work. Finally, if the user provides a desired price and a desired time, the result will be a number of program outputs.

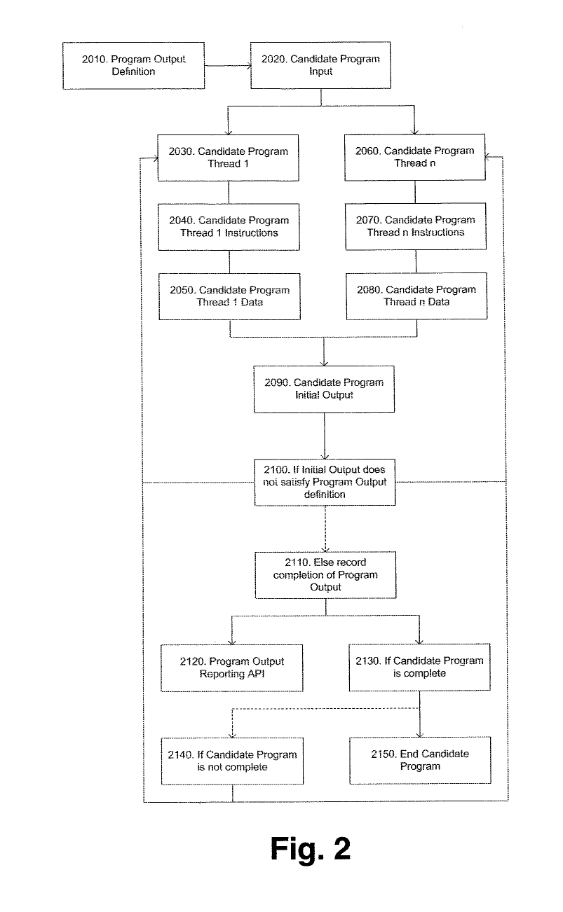

Referring now to FIG. 2, a flowchart illustrating steps for analyzing a candidate program is shown. At step 201, the definition of the required candidate program output is input. The definition of the required candidate program output is the output that the user would like to receive as a result of executing the candidate program. In the case of the chess playing program, the definition of the candidate program output is a recommended next move. At step 202, the input for the candidate program is provided. The input is the starting state of the candidate program. In the chess playing program example, the input is the current position of the chess pieces on the board.

A parallel program typically splits its tasks into subtasks using threads. A thread executes a particular subtask and a parallel program typically has many threads executing different subtasks simultaneously. In general, a parallel program that creates threads that can execute in parallel creates fewer, the same number as, or more threads than there are parallel processing hardware elements available to execute those threads. In the case where there are fewer or the same number of threads compared to the number of parallel processing elements, the threads that the program creates will all have finished executing when the first set of threads that execute on the parallel processing hardware finishes executing. For example, a processor that can execute four threads simultaneously will execute a first batch of up to four threads simultaneously. If the parallel program creates no more than four threads, the program will be able to generate the appropriate output. If the program creates more than four threads, the next batch of threads will need to execute on the parallel processing hardware.

A candidate program's first thread is shown in step 203. In the chess game example, the first thread takes as an input the positions of the chess pieces on the board, and simulates the progression of the game starting with one possible chess move. The first thread's instruction store is shown at step 204. The instructions for the parallel program thread tell the thread what action to perform. In the chess game example, the instruction store at step 204 tells the first thread how to run the simulation. At step 205, the data associated with the first thread (e.g., the input to the thread) is stored. The intermediate calculation outputs and the final output of the thread are stored here as well. At step 206, a different thread than the first thread is shown. This “nth” thread of the candidate program takes the same inputs as the first thread, but starts with a different chess move than any of the other threads (e.g., the first thread). The instruction store for the nth thread is shown at step 207, while the data store for thread n is shown at step 208. The initial output of the parallel program is shown at step 209. In the case of the chess playing program, this output is the scores of all of the moves that the threads have so far evaluated. At step 210, the parallel program checks to see whether it has evaluated enough moves to be able to recommend a particular move to the player, or if it has to evaluate more moves before making a recommendation.

Once it is available, the program output is recorded at step 211. In addition, completion of the output of the program is signaled to the Program Output Reporting API at step 212. At step 213, a check is performed to see if the parallel program is complete.

It may be the case that the parallel program is intended to create more than one program output. In the case of the chess playing program, it might be desired to recommend not only the best move given the current state of the board, but to compute the best opponent's move in response as well. In that case, the program would be run again through step 214, with the new state of the board incorporating the recommended move as an input. If the parallel program is complete, the program ends at step 215.

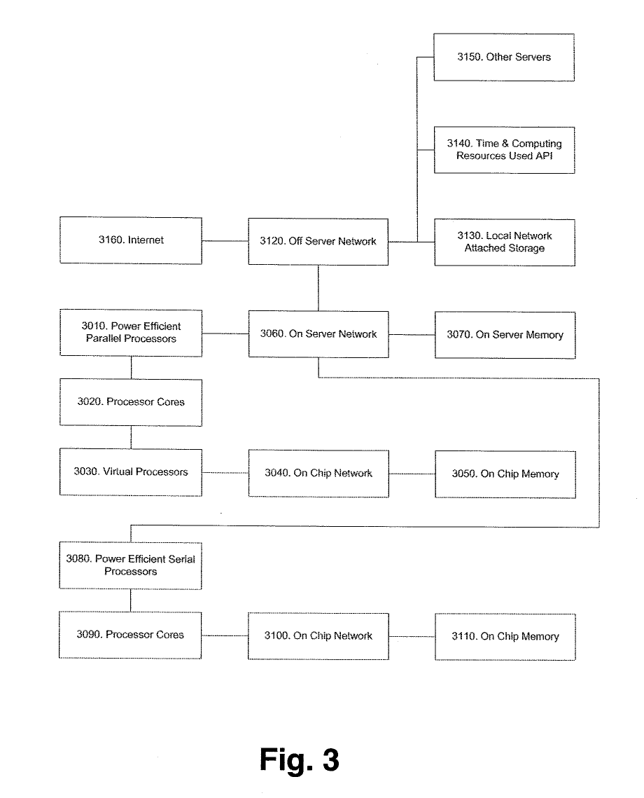

FIG. 3 is a block diagram illustrating elements of the parallel computing resources in accordance with a preferred embodiment of this invention. A plurality of power-efficient parallel processors 3010 are designed to execute parallel programs with higher efficiency than other processors. Each of the power efficient parallel processors 3010 has a plurality of processing cores 3020. Each of the plurality of processing cores 3020 has a plurality of virtual processors 3030 that are responsible for executing threads of parallel programs. Each of the virtual processors 3030 are connected to an on chip network 3040 that allows the virtual processors 3030 to communicate with other virtual processors and with on chip memory 3050. Each parallel processor 3010 has an amount of on-chip memory 3050 that is used to store data that can be accessed by the virtual processors 3030 with lower latency than any other memory across the parallel computing resources. An on-server network 3060 allows the parallel processors 3010 in a given server to communicate with other parallel processors 3010 on the server as well as with on-server memory 3070 and with the off server network 3120.

Each server has an on-server network 3060 connection to the off server network 3120, on server memory 3070, a plurality of power efficient parallel processors 3010, and one and or more power efficient serial processors 3080. The on-server memory 3070 can be accessed at a higher latency compared to the on chip memory 3050 of the power efficient parallel processors 3010 or the on-chip memory 3110 of the power efficient serial processors 3080. The power efficient serial processors 3080 can be, for example, x86 based processors such as those manufactured by INTEL and AMD. These processors are used to compute the threads of the parallel program that other threads serially depend upon.

As Amdahl's law implies, many parallel programs have threads that are serial. Where possible, it is advantageous to compute these threads on power efficient serial processors. Each serial processor 3080 has one or more processor cores 3090 that perform computations for the threads assigned to the serial processor 3080. An on chip network 3100 is used by the processor cores 3090 of the power efficient serial processor 3080 to communicate with the other processor cores on the processor and with the on chip memory 3110 on the processor. The on chip memory 3110 stores data that can be accessed by the processor cores 3090 of the power efficient serial processor 3090 with lower latency than any other memory across the parallel computing resources.

The off server network 3120 connects the servers with network attached storage 3130, other servers 3150, the Internet 3160 and with the Time and Computing Resources Used Database 3140. The network attached storage 3130 provides storage of data that can be accessed by the processors with higher latency than the on server memory 3070. The Time and Computing Resources Used Database 3140 is used by the parallel computing resources to report the amount of resources and time used by a candidate program.

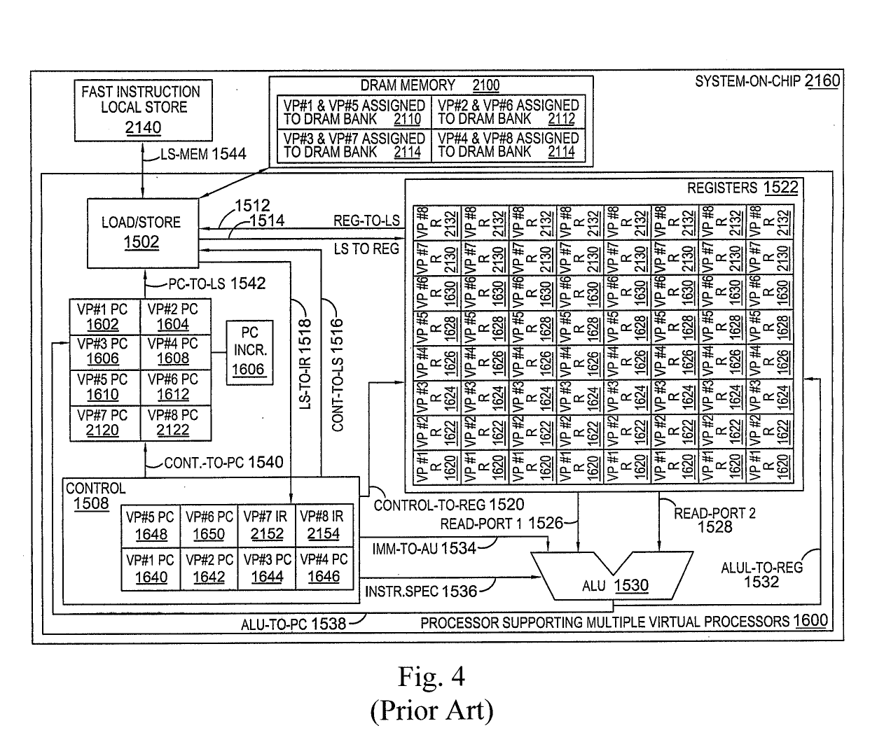

The parallel computing architecture is one example of an architecture that may be used to implement the program execution pricing features of this invention. The architecture is further described in U.S. Patent Application Publication No. 2009/0083263 (Felch et al.), which is incorporated by reference herein. FIG. 4 is a block diagram schematic of a processor architecture 2160 utilizing on-chip DRAM 2100 memory storage as the primary data storage mechanism and Fast Instruction Local Store, or just Instruction Store 2140, as the primary memory from which instructions are fetched. The Instruction Store 2140 is fast and is preferably implemented using SRAM memory. In order for the Instruction Store 2140 to not consume too much power relative to the microprocessor and DRAM memory, the Instruction Store 2140 can be made very small. Instructions that do not fit in the SRAM are stored in and fetched from the DRAM memory 2100. Since instruction fetches from DRAM memory are significantly slower than from SRAM memory, it is preferable to store performance-critical code of a program in SRAM. Performance-critical code is usually a small set of instructions that are repeated many times during execution of the program.

The DRAM memory 2100 is organized into four banks 2110, 2112, 2114 and 2116, and requires 4 processor cycles to complete, called a 4-cycle latency. In order to allow such instructions to execute during a single Execute stage of the Instruction, eight virtual processors are provided, including new VP#7 (2120) and VP#8 (2122). Thus, the DRAM memories 2100 are able to perform two memory operations for every Virtual Processor cycle by assigning the tasks of two processors (for example VP#1 and VP#5 to bank 2110). By elongating the Execute stage to 4 cycles, and maintaining single-cycle stages for the other 4 stages comprising: Instruction Fetch, Decode and Dispatch, Write Results, and Increment PC; it is possible for each virtual processor to complete an entire instruction cycle during each virtual processor cycle. For example, at hardware processor cycle T=1 Virtual Processor #1 (VP#1) might be at the Fetch instruction cycle. Thus, at T=2 Virtual Processor #1 (VP#1) will perform a Decode & Dispatch stage. At T=3 the Virtual Processor will begin the Execute stage of the instruction cycle, which will take 4 hardware cycles (half a Virtual Processor cycle since there are 8 Virtual Processors) regardless of whether the instruction is a memory operation or an ALU 1530 function. If the instruction is an ALU instruction, the Virtual Processor might spend cycles 4, 5, and 6 simply waiting. It is noteworthy that although the Virtual Processor is waiting, the ALU is still servicing a different Virtual Processor (processing any non-memory instructions) every hardware cycle and is preferably not idling. The same is true for the rest of the processor except the additional registers consumed by the waiting Virtual Processor, which are in fact idling. Although this architecture may seem slow at first glance, the hardware is being fully utilized at the expense of additional hardware registers required by the Virtual Processors. By minimizing the number of registers required for each Virtual Processor, the overhead of these registers can be reduced. Although a reduction in usable registers could drastically reduce the performance of an architecture, the high bandwidth availability of the DRAM memory reduces the penalty paid to move data between the small number of registers and the DRAM memory.

This architecture 1600 implements separate instruction cycles for each virtual processor in a staggered fashion such that at any given moment exactly one VP is performing Instruction Fetch, one VP is Decoding Instruction, one VP is Dispatching Register Operands, one VP is Executing Instruction, and one VP is Writing Results. Each VP is performing a step in the Instruction Cycle that no other VP is doing. The entire processor's 1600 resources are utilized every cycle. Compared to the naïve processor 1500 this new processor could execute instructions six times faster.

As an example processor cycle, suppose that VP#6 is currently fetching an instruction using VP#6 PC 1612 to designate which instruction to fetch, which will be stored in VP#6 Instruction Register 1650. This means that VP#5 is Incrementing VP#5 PC 1610, VP#4 is Decoding an instruction in VP#4 Instruction Register 1646 that was fetched two cycles earlier. VP #3 is Dispatching Register Operands. These register operands are only selected from VP#3 Registers 1624. VP#2 is Executing the instruction using VP#2 Register 1622 operands that were dispatched during the previous cycle. VP#1 is Writing Results to either VP#1 PC 1602 or a VP#1 Register 1620.

During the next processor cycle, each Virtual Processor will move on to the next stage in the instruction cycle. Since VP#1 just finished completing an instruction cycle it will start a new instruction cycle, beginning with the first stage, Fetch Instruction.

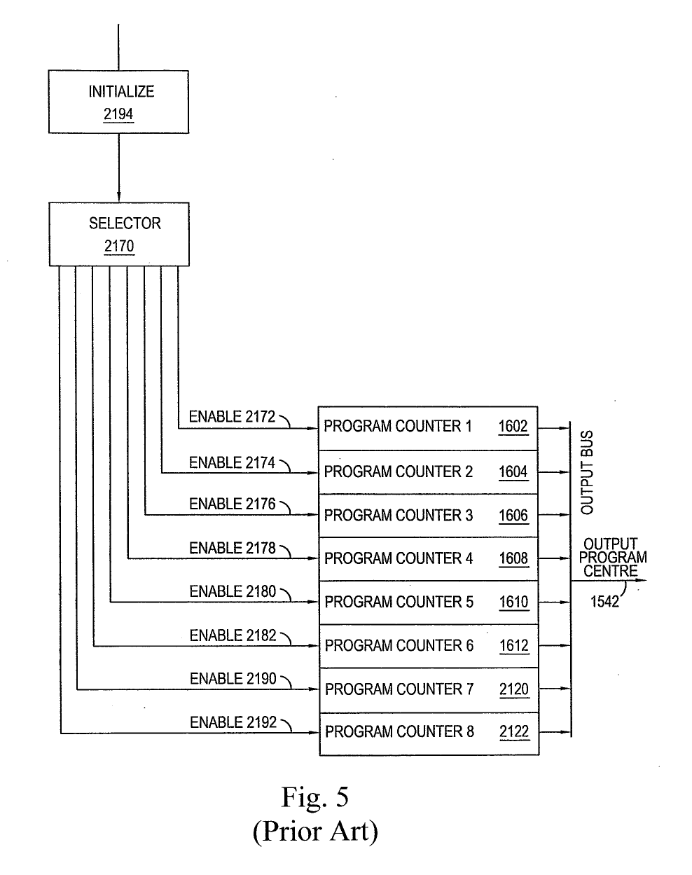

Note, in the architecture 2160, in conjunction with the additional virtual processors VP#7 and VP#8, the system control 1508 now includes VP#7 IR 2152 and VP#8 IR 2154. In addition, the registers for VP#7 (2132) and VP#8 (2134) have been added to the register block 1522. Moreover, with reference to FIG. 5, a Selector function 2110 is provided within the control 1508 to control the selection operation of each virtual processor VP#1-VP#8, thereby maintaining the orderly execution of tasks/threads, and optimizing advantages of the virtual processor architecture the has one output for each program counter and enables one of these every cycle. The enabled program counter will send its program counter value to the output bus, based upon the direction of the selector 2170 via each enable line 2172, 2174, 2176, 2178, 2180, 2182, 2190, 2192. This value will be received by Instruction Fetch unit 2140. In this configuration the Instruction Fetch unit 2140 need only support one input pathway, and each cycle the selector ensures that the respective program counter received by the Instruction Fetch unit 2140 is the correct one scheduled for that cycle. When the Selector 2170 receives an initialize input 2194, it resets to the beginning of its schedule. An example schedule would output Program Counter 1 during cycle 1, Program Counter 2 during cycle 2, etc. and Program Counter 8 during cycle 8, and starting the schedule over during cycle 9 to output Program Counter 1 during cycle 9, and so on . . . A version of the selector function is applicable to any of the embodiments described herein in which a plurality of virtual processors are provided.

To complete the example, during hardware-cycle T=7 Virtual Processor #1 performs the Write Results stage, at T=8 Virtual Processor #1 (VP#1) performs the Increment PC stage, and will begin a new instruction cycle at T=9. In another example, the Virtual Processor may perform a memory operation during the Execute stage, which will require 4 cycles, from T=3 to T=6 in the previous example. This enables the architecture to use DRAM 2100 as a low-power, high-capacity data storage in place of a SRAM data cache by accommodating the higher latency of DRAM, thus improving power-efficiency. A feature of this architecture is that Virtual Processes pay no performance penalty for randomly accessing memory held within its assigned bank. This is quite a contrast to some high-speed architectures that use high-speed SRAM data cache, which is still typically not fast enough to retrieve data in a single cycle.

Each DRAM memory bank can be architected so as to use a comparable (or less) amount of power relative to the power consumption of the processor(s) it is locally serving. One method is to sufficiently share DRAM logic resources, such as those that select rows and read bit lines. During much of DRAM operations the logic is idling and merely asserting a previously calculated value. Using simple latches in these circuits would allow these assertions to continue and free-up the idling DRAM logic resources to serve other banks. Thus the DRAM logic resources could operate in a pipelined fashion to achieve better area efficiency and power efficiency.

Another method for reducing the power consumption of DRAM memory is to reduce the number of bits that are sensed during a memory operation. This can be done by decreasing the number of columns in a memory bank. This allows memory capacity to be traded for reduced power consumption, thus allowing the memory banks and processors to be balanced and use comparable power to each other.

The DRAM memory 2100 can be optimized for power efficiency by performing memory operations using chunks, also called “words”, that are as small as possible while still being sufficient for performance-critical sections of code. One such method might retrieve data in 32-bit chunks if registers on the CPU use 32-bits. Another method might optimize the memory chunks for use with instruction Fetch. For example, such a method might use 80-bit chunks in the case that instructions must often be fetched from data memory and the instructions are typically 80 bits or are a maximum of 80 bits.

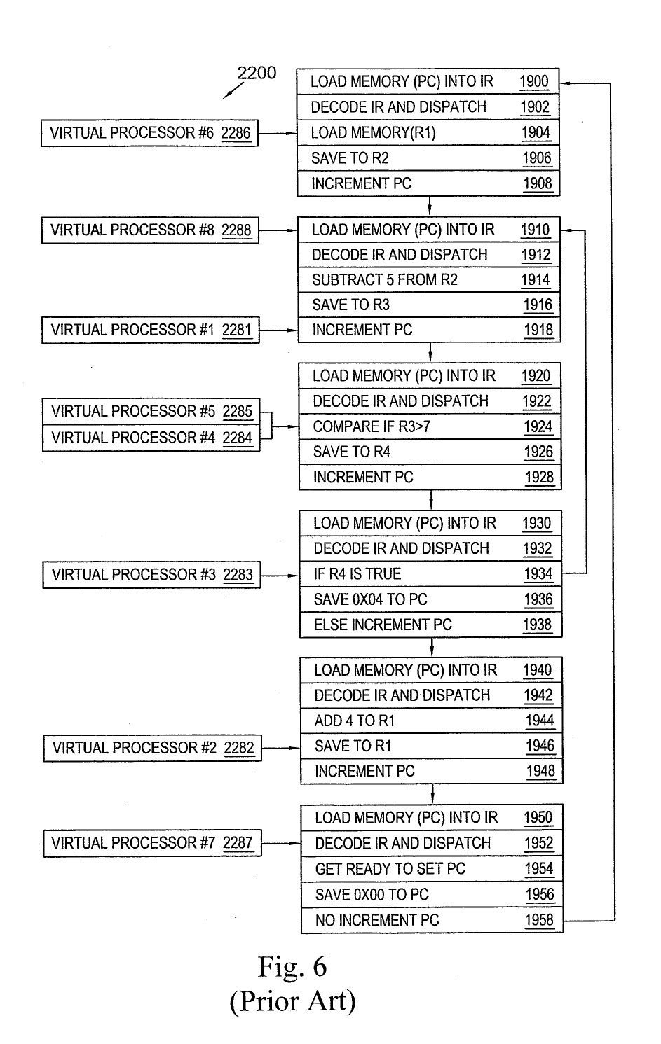

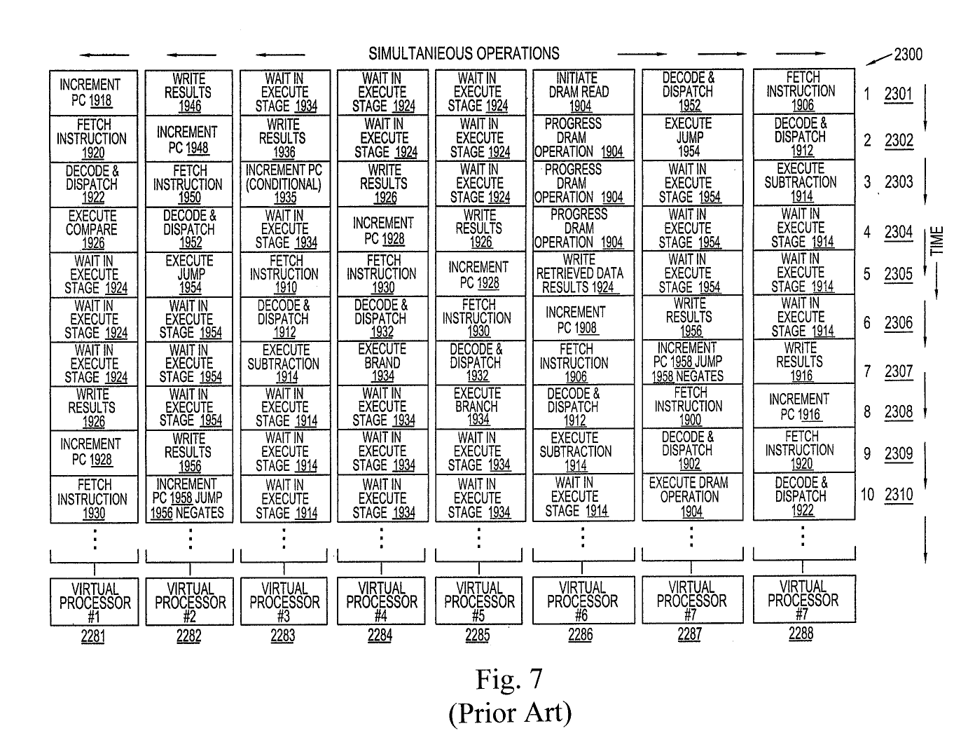

FIG. 6 is a block diagram 2200 showing an example state of the architecture 2160 in FIG. 4. Because DRAM memory access requires four cycles to complete, the Execute stage (1904, 1914, 1924, 1934, 1944, 1954) is allotted four cycles to complete, regardless of the instruction being executed. For this reason there will always be four virtual processors waiting in the Execute stage. In this example these four virtual processors are VP#3 (2283) executing a branch instruction 1934, VP#4 (2284) executing a comparison instruction 1924, VP#5 2285 executing a comparison instruction 1924, and VP#6 (2286) a memory instruction. The Fetch stage (1900, 1910, 1920, 1940, 1950) requires only one stage cycle to complete due to the use of a high-speed instruction store 2140. In the example, VP#8 (2288) is in the VP in the Fetch Instruction stage 1910. The Decode and Dispatch stage (1902, 1912, 1922, 1932, 1942, 1952) also requires just one cycle to complete, and in this example VP#7 (2287) is executing this stage 1952. The Write Result stage (1906, 1916, 1926, 1936, 1946, 1956) also requires only one cycle to complete, and in this example VP#2 (2282) is executing this stage 1946. The Increment PC stage (1908, 1918, 1928, 1938, 1948, 1958) also requires only one stage to complete, and in this example VP#1 (1981) is executing this stage 1918. This snapshot of a microprocessor executing 8 Virtual Processors (2281-2288) will be used as a starting point for a sequential analysis in FIG. 7.

FIG. 7 is a block diagram 2300 illustrating 10 cycles of operation during which 8 Virtual Processors (2281-2288) execute the same program but starting at different points of execution. At any point in time (2301-2310) it can be seen that all Instruction Cycle stages are being performed by different Virtual Processors (2281-2288) at the same time. In addition, three of the Virtual Processors (2281-2288) are waiting in the execution stage, and, if the executing instruction is a memory operation, this process is waiting for the memory operation to complete. More specifically in the case of a memory READ instruction this process is waiting for the memory data to arrive from the DRAM memory banks This is the case for VP#8 (2288) at times T=4, T=5, and T=6 (2304, 2305, 2306).

When virtual processors are able to perform their memory operations using only local DRAM memory, the example architecture is able to operate in a real-time fashion because all of these instructions execute for a fixed duration.

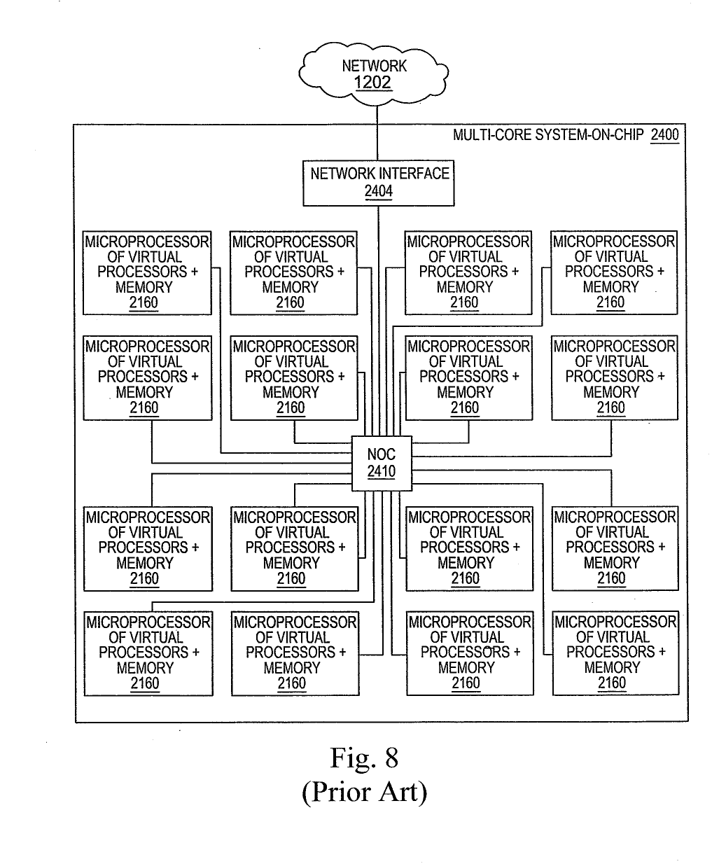

FIG. 8 is a block diagram of a multi-core system-on-chip 2400. Each core is a microprocessor implementing multiple virtual processors and multiple banks of DRAM memory 2160. The microprocessors interface with a network-on-chip (NOC) 2410 switch such as a crossbar switch. The architecture sacrifices total available bandwidth, if necessary, to reduce the power consumption of the network-on-chip such that it does not impact overall chip power consumption beyond a tolerable threshold. The network interface 2404 communicates with the microprocessors using the same protocol the microprocessors use to communicate with each other over the NOC 2410. If an IP core (licensable chip component) implements a desired network interface, an adapter circuit may be used to translate microprocessor communication to the on-chip interface of the network interface IP core.

FIG. 9 shows the database of resources and time 900 in accordance with a preferred embodiment of the invention. The database of resources and time 900 contains records for different amounts of computing resources and time that the computing resources will be used to run a candidate parallel program. These computing resources may be, for example, parallel processors 3010, virtual processors 3030, serial processors 3080, on chip memory 3050, 3110 and on server memory 3070. However, other embodiments might include other computing resources available to the parallel computing system.

Preferably, the Database of Resources and Time 900 maintains sufficient configuration data for the runs of the candidate parallel program so that the amount of each computing resource is varied on at least one run while holding the other resources constant. Runs 1 and 2 in the figure vary the amount of virtual processors 3030 available. Run 3 is a baseline run. The baseline run allocates an amount of computing resources to the run such that the resources are in the same proportion to each other as the resources are to each other in the entire system available to run the candidate parallel program. The baseline run uses 1024 virtual processors 3030 and one serial processor 3080. However, the baseline run may use any combination of resources deemed to be representative of a baseline. Returning to FIG. 9, runs 4 and 5 vary the number of serial processors 3080 available. Runs 6 and 7 vary the amount of on chip memory 3050, 3110 available. Runs 8 and 9 vary the amount of on server memory 3070 available. Runs 10 and 11 vary the amount of off server memory 3130 available. Runs 12 and 13 vary the amount of time allotted for the runs. This set of runs allows for all of the computing resources tracked in the database to be varied from the baseline in two different runs of the candidate parallel program.

Referring to FIG. 10A, a Program Output API database 1000 is shown. The Program Output API database 1000 tracks the number of program outputs completed by each run of the candidate parallel program, which run the outputs were generated on and the candidate parallel program ID. The parallel program ID is stored because different candidate parallel programs will be run on the system and data relating to their program outputs will all be stored in the Program Output API database 1000, and a method of distinguishing between them is required. FIG. 10B shows the Time and Computing Resources Used Database 1050, which stores the amount of computing resources used for each run of the candidate parallel programs and the amount of time those resources were used for each run. The fields for each candidate program in this database correspond to the fields in the Database of Resources and Time 900.

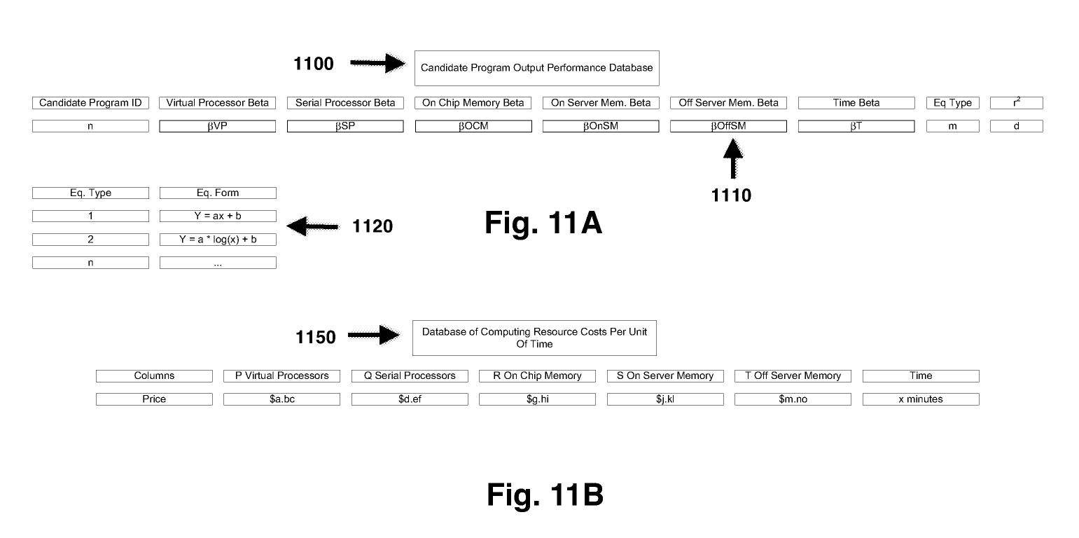

FIG. 11A shows the Candidate Program Output Performance Database 1100. The Candidate Program Output Performance Database 1100 includes two tables. The first table 1110 contains the candidate program ID and the betas for all of the computing resources, with the beta for time, the equation type and the r². The equation type records the type of equation used to run the regression that generates the betas. In the case of a linear regression, the form of the equation is, in general, y=a*x+b. Other kinds of equations that can be used to run the regression are, for example, logarithmic equations. The r² is a measure of how well the generated regression explains the data provided. A higher r² value indicates a better fit for the regression. In the case of using multiple equation types to generate multiple regressions, the equation type that generates the highest r² value is generally the best equation type to use. The second table 1120 contains a list of equation forms and equation types to describe them. The betas for a candidate program are derived by executing a regression analysis on the data from the Time & Computing Resources Used Database 3140 and the Program Output API Database 1000. This regression analysis uses the Program Output data from the Program Output API Database 1000 as the dependent variable and the data on computing resources from the Time & Computing Resources Used Database 3140 as the independent variables. The betas are calculated for all of the independent variables that are then stored in the first table 1110 of the Candidate Program Output Performance Database 1100.

The type of equation used for the regression (selected from the second table 1120 in of the Candidate Program Output Performance Database) is also stored in the first table 1110. The equation used is the one that produces the highest r² value, which is also stored. Notably, if the r² value for the linear regression equation is higher than for other equations, the candidate parallel program is likely to be embarrassingly parallel. An embarrassingly parallel workload is one for which little or no effort is required to separate the problem into a number of parallel tasks. If the logarithmic regression equation produces the higher r² then the candidate parallel program is likely to have limits to the extent to which it can be accelerated by adding parallel hardware to execute it as predicted by Amdahl's law.

In the case of the chess playing program, the program would be run according to the specifications in the Database of Resources and Time 900 and then the resulting data would be used in regressions. The betas, as stored, quantify how many more program outputs (predicted best moves) the chess playing program will compute given a unit increase in the computing resource to which a given beta corresponds. Referring to FIG. 11B, the Database of Computing Resource Prices Per Unit of Time 1150 stores the price to use each computing resource for a given amount of time, which is also stored in the Database of Computing Resource Prices Per Unit of Time 1150.

FIG. 12 illustrates the Database of Computing Resources Ratios 1200 in accordance with a preferred embodiment of this invention. This database records the ratios of the amount of each computing resource available in the system to all other computing resources available in the system. Preferably, each computing resource has a row of the database devoted to it. Each column represents a computing resource available in the system. The ratio of the amount of a computing resource (resource A) to another computing resource (resource B) is determined by looking at the row in the database devoted to resource A and then at the intersection of that row with the column devoted to resource B. The data stored at that intersection is a number that is calculated by dividing the amount of resource A available in the system by the amount of resource B available in the system.

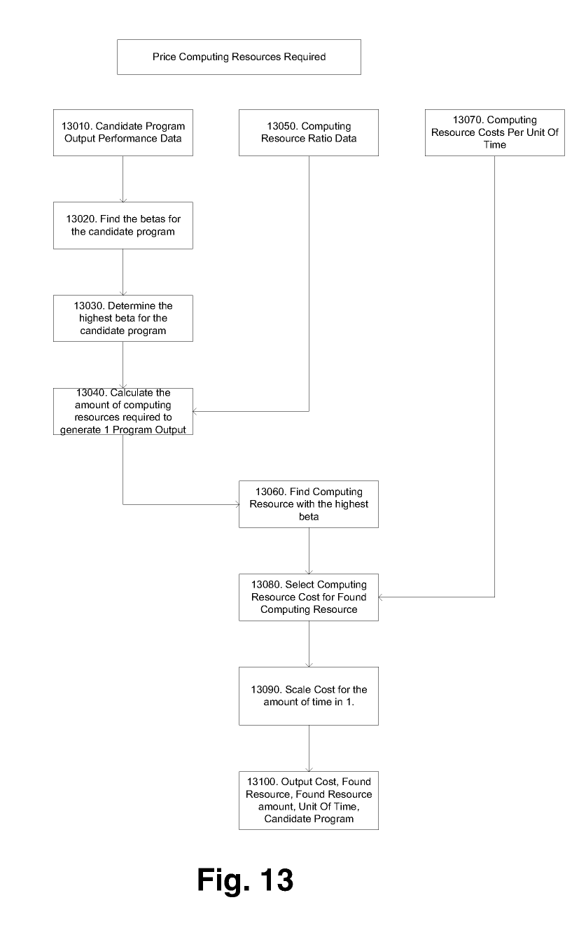

FIG. 13 shows the procedure by which the system determines the price of the computing resources required per candidate parallel program output. To determine this price, the Candidate Program Output Performance Data is input at step 1301. At step 1302, the system finds the betas for the candidate parallel program. Next, at step 1303, it is determined which of the betas of the computing resources is the highest. At step 1304, the amount of computing resources required to generate one Program Output of the candidate parallel program is calculated. For this calculation, the resources allocated are in the same proportion to each other as they are in the parallel computing system as a whole. At step 1306 the computing resource with the highest beta for the candidate parallel program is found and the price is selected based on the data from the computing resource prices per unit of time database. The price for the found computing resource is based in part on the data input at step 1301. At step 1309, the identified price is multiplied by the ratio of the time in step 1301 to the time in step 1307. At step 1310, the multiplied price from step 1309, the found resource from 1306, the found resource amount from 1304, the unit of time from 1301 and the Candidate Program ID are output.

In the case of the chess playing program, the system would load the betas for the program runs, determine the highest beta which might be the beta for virtual processors. Use the regression equation and the betas to determine the amount of computing resources required to compute one program output in the amount of time from step 1301 such that the computing resources are allocated in proportion to their presence in the overall system. Then find the computing resource that has the highest beta, in this case virtual processors. Select the price for virtual processors from step 1307. Scale the price appropriately and then output the data.

FIG. 14 shows the Output Pricing Database 1400 for storing pricing data of candidate programs determined based on the steps of FIGS. 1 and 13. Specifically, each row of the database stores the Candidate Program ID, the price as calculated via the steps in FIG. 13, the Found Resource ID, which identifies the found computing resource as determined by the steps in FIG. 13 the amount of the found resource, and the amount of time. This data shows the price, the resource, the amount of the resource and the amount of time required to generate an output from the candidate program.

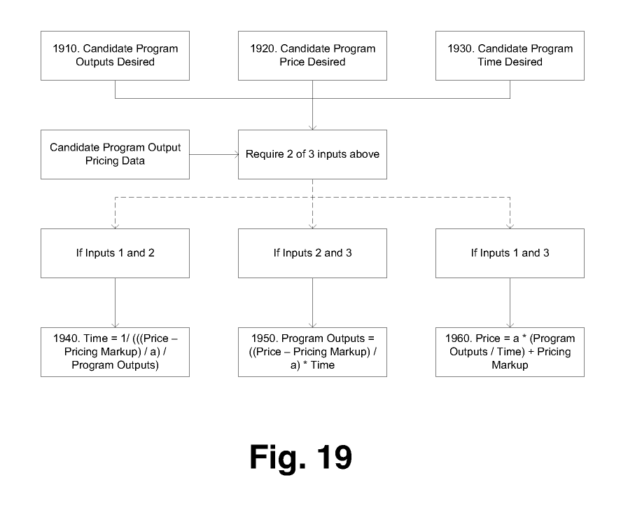

In one embodiment, FIG. 19 shows how a program is priced when a user wants to run the program after the pricing data have been generated and stored as shown in FIG. 14, but no auction is conducted. That is, the processing system provides a set price for executing the user's candidate program. The term a that appears is derived from the data stored as shown in FIG. 14 and is a constant that relates price to time and program outputs. The role of the constant a is also seen in 1940, 1950 and 1960. In the case of the chess playing program, a user that wants to run the program in the future may specify two out of the following three parameters: the price to run the program, the amount of time to run the program, the number of program outputs (in the case of the chess playing program, predicted best moves) that the program should generate. Given any two of those three parameters in a non-auction context, the pricing system will tell the user the value of the third that the user can accept or reject.

For example, if the user of the chess playing program says that she wants to get 1 predicted best move in 1 minute, then the system would load the pricing data from FIG. 14 that specifies the price, the number of outputs and the time that were recorded during the candidate runs of the system earlier. If the number of outputs were 1, the time 10 minutes and the cost $10 in the candidate runs, and the equation type for the program in the Candidate Program Output Performance Database (FIG. 11A) were linear, then the system would compute the amount of computing resources required to provide the same output in 10× less time. In this case, the amount of computing resources required are 10× more resources, which implies 10× higher price for the user. Therefore, the system would inform the user that computing 1 output in 1 minute for this program will cost $100.

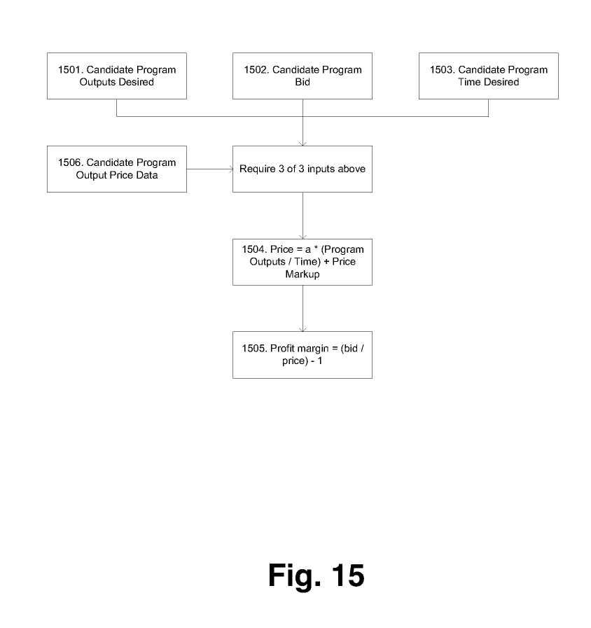

In another embodiment, FIG. 15 shows how a program is priced when a user wants to run the program after the pricing data has been generated and stored, as shown in FIG. 14 and an auction is to be conducted. The term a that appears is derived from the data stored as shown in FIG. 14 and is a constant that relates price to time and program outputs. The role of the constant a is also seen in step 1504. In the case of the chess playing program, a user that wants to run the program in the future specifies the program outputs desired, the time desired and the bid. Given the program outputs desired and the time desired, the pricing system will generate the price to run the program in step 1504. The profit margin for the program will then be calculated in step 1505

For example, if the user of a chess playing program says that she wants to get one predicted best move in one minute, then the system loads the pricing data in step 1506 that specifies the price, the number of outputs and the time that were recorded during the candidate runs of the system earlier. If the number of outputs were 1, the time 10 minutes and the cost $10 in the candidate runs, and the equation type for the program in the Candidate Program Output Performance Database 1100 were linear, then the system would compute the amount of computing resources required to provide the same output in 10× less time. In this case, the amount of computing resources required are 10× more resources, which implies 10× higher price for the user. Therefore, the system would calculate that computing one output in one minute for this program will be priced at $100.

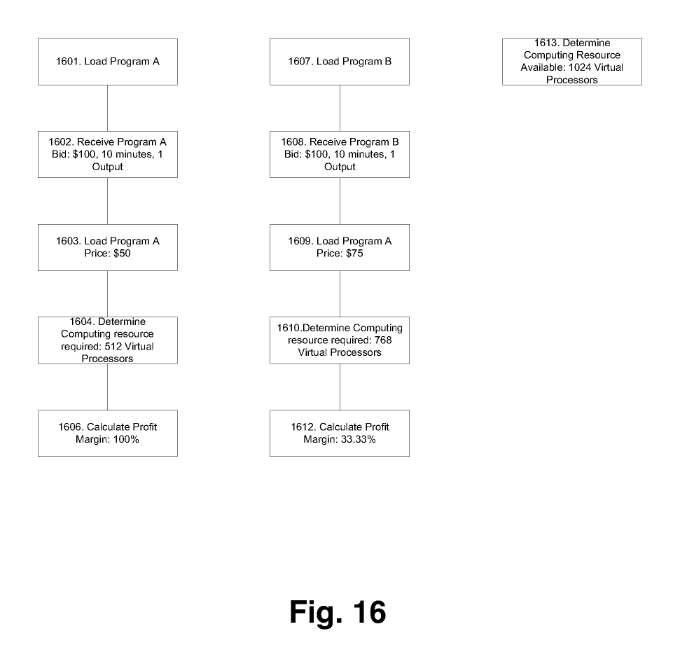

Referring now to FIG. 16, a block diagram illustrating competing bids for execution of two programs (A and B) on the parallel processing system in accordance with a preferred embodiment of this invention is shown. At step 1601, Program A is received by the processing system. The program may be uploaded by the user or may be selected by from a plurality of programs hosted and/or provided by the processing system. At step 1602, a bid for execution of Program A is received from a first user, the bid includes a price the user is willing to pay to run Program A, the number of desired outputs and the time those outputs must be provided in. In this example, the bid price for Program A is $100 for 1 output in 10 minutes. Note that steps 1601 and 1602 may be a single step. The cost to run program A is determined by the processing system at step 1603 based on an analysis of the program, as described with respect to FIG. 1. The system determines the cost of running program A to be $50. At step 1604, the amount of computing resource required to run program A and generate the desired outputs in the desired time is calculated. Here, 512 virtual processors are required to fulfill the bid for program A. At step 1606, the profit margin to the operator for running program A is calculated. Since the cost of running program A was determined to be $50 and the bid was for $100, the profit margin is determined to be 100%.

At step 1607, Program B is received by the processing system. As with Program A, the program may be uploaded by the user or may be selected by the user from a plurality of programs hosted and/or provided by the processing system. At step 1608, a bid for execution of Program B is received from another user, the bid includes a price the other user is willing to pay to run Program B. Here, the bid price to run program B is also $100 for 1 output in 10 minutes. Note that steps 1607 and 1608 may be performed in one step. At step 1609, the price to run program B is determined by the processing system based on an analysis of the program, as described with reference to FIG. 1. Here, the determined price to run the program is $75. At step 1610, the amount of computing resources required to run program B so that the conditions of the bid are fulfilled are calculated. In the case of the bid for Program B, 768 virtual processors are required to fulfill the bid. At step 1612, the profit margin to the operator for running program B is calculated. Here, the profit margin is determined to be 33.33%.

At step 1613, the amount of computing resources available is compared to the amount of resources required to fulfill the received bids. In this case, there are 1024 virtual processors available in the processing system and fulfillment of bids A and B at the same time requires 1280 virtual processors. Thus, the processing system cannot fulfill both bids for programs A and B. In this case, the system would run program A and not program B because the bid for program A has a higher profit margin to the operator and there are not enough computing resources to run both program A and program B at the same time. Thus, the bid for program B would not be fulfilled. In other embodiments, the processing system may offer to the user an opportunity to change the bid for Program B, for example to fulfill the bid at a later time or to reduce the amount of resources required (e.g., by providing a smaller number of program outputs or allowing more time to complete the work).

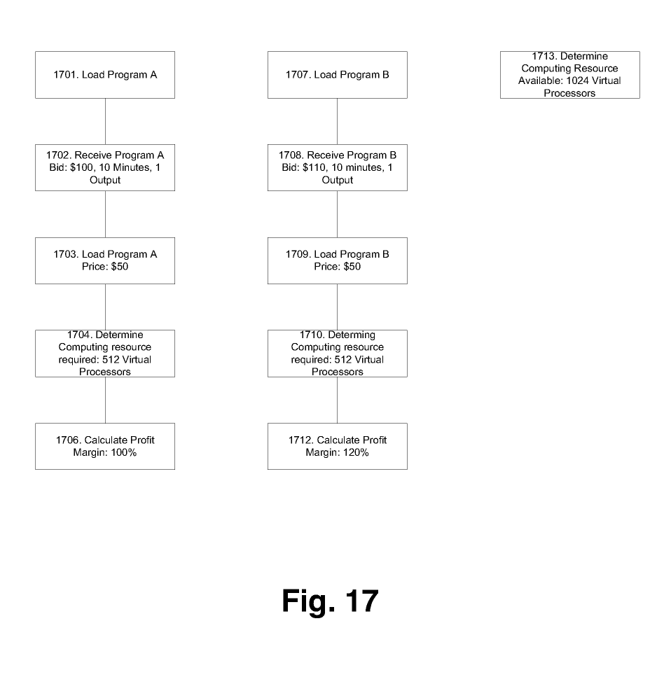

FIG. 17 is a block diagram illustrating another example of competing bids for execution of two programs (A and B) on the processing system. The bid for program A in FIG. 17 is the same as the bid for program A in FIG. 16. At step 1701, program A is received by the processing system or selected by the user from a plurality of programs available within the processing system. The bid for program A is received at step 1702, including a price the user is willing to pay, the desired number of outputs and the time to calculate those outputs. The bid for program A is $100 for 1 output in 10 minutes. The cost to run program A within the processing system is determined at step 1703 in the manner described with reference to FIG. 1 above. The cost within the processing system is $50. At step 1704, the amount of computing resources required to run program A and generate the desired outputs in the desired time is determined. Again, 512 virtual processors are required to fulfill the bid. At step 1706 the profit margin to the operator for running program A is calculated. Again, the profit margin for the bid for program A is 100%.

At step 1707, program B is received by the processing system or selected by the user from a plurality of programs available within the processing system. At step 1708, the bid for Program B is received. The bid for program B includes a bid price of $110 for 1 output in 10 minutes. At step 1709, the cost to run program B is calculated to be $50. Next, at step 1710, the amount of computing resources required to run program B and generate the desired outputs in the desired time is calculated. It is determined that 512 virtual processors are required to fulfill the bid. At step 1712, the profit margin to the operator for running program B is determined to be 120%. In this case, either the programmers of program B have improved the program to require less system resources, or the user of program B is satisfied with fewer program outputs.

At step 1713, the bids are compared to the amount of computing resources available. A total of 1024 virtual processors are required to fulfill both bids A and B and the processing system has 1024 virtual processors available. Therefore, the system would run both program A and program B. Program B now has a higher profit margin to the operator, so if the system did not have enough resources to run both programs, the system would run Program B and reject the bid for program A.

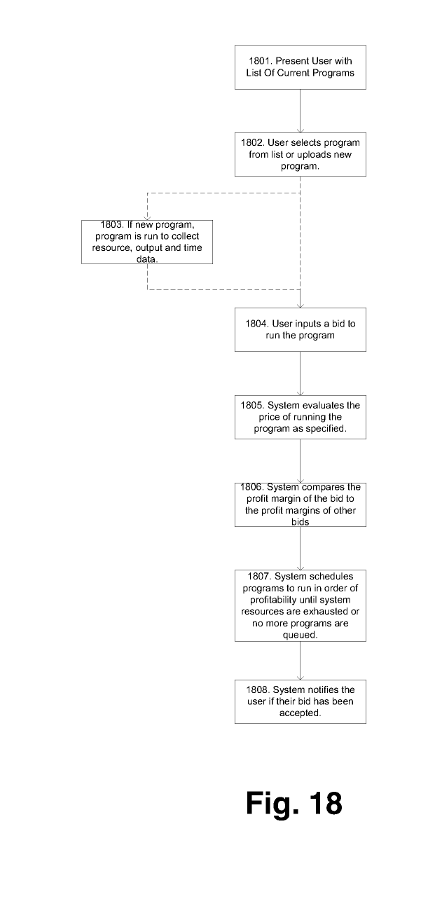

Referring now to FIG. 18, a block diagram showing a high level representation of the system for bidding for execution of programs in the parallel processing program in accordance with a preferred embodiment of the invention. At step 1801, the system presents the user with a list of current programs. This list may be presented via a web page or the like. The current programs are programs that have already been run on the parallel processing system to generate output, resource and time data, as described with respect to FIG. 1 above. At step 1802, the user selects a program to run from the list of current programs or chooses to upload a program that is not on the list of current programs. Again, the uploading interface may be presented to the user via a web page or the like.

If the user uploads a new program, at step 1803, the program is run to collect resource, output and data information. Multiple runs are performed using a number of different configurations of resources and time to gather data on the use of those resources and the outputs that the program generates. Once the new program has been analyzed, the system is ready to receive a bid from the user. In an alternative embodiment, the bid may be received prior the analyzing of the program. However, in that case, a decision on whether to accept or deny the bid may be delayed while the program is being analyzed. In the case where the user has selected a previously analyzed program, the bid may be received immediately and a determination on whether to accept the bid may be made.

The user inputs a bid to run the uploaded or selected program at step 1804. The bid specifies the number of program outputs desired, the amount of time allowed to calculate those outputs and the amount of money that the user is prepared to pay to receive those outputs in the allowed amount of time.

At step 1805, the data on the program's use of resources and time to produce outputs is used to determine the system's price to run to the program to the user's specifications in the bid. That is, the system determines the cost to output the required number of outputs in the desired amount of time. Once the cost has been determined, at step 1806 the system compares the calculated price to the amount of money specified in the bid in order to calculate the profit margin for running the program with the requirements specified in the bid. The system then compares the profit margin of the current bid with the profit margins of the other bids received by the system and orders them in order of profit margin.

At step 1807 the system schedules the programs to run in the order of highest profit margin to lowest profit margin until the amount of computing resources available in the system is exhausted or there are no more programs to schedule.

At step 1808, the system notifies the user whether the bid has been accepted depending on the outcome of step 1807. This notification can take place via a webpage or the like. If the user's bid was not accepted, the system preferably allows the user to revise the bid by changing any of the variables associated with the bid (price; time to completion and number of desired outputs). In addition, the user may attempt to improve performance of the program by making modifications in the code. In this case, an updated program may be resubmitted and the analysis of step 1803 re-run. If the performance of the updated program is improved, the previous bid may now be accepted.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An automated auction-based method of determining price to execute one or more candidate programs on a parallel computing system, the parallel computing system comprising a plurality of computing resources, wherein each of the computing resources has a price per unit of time, the method comprising:
(a) performing a plurality of executions of a candidate program, each execution being for a recorded amount of time and using different amounts of the computing resources;
(b) measuring number of program outputs completed during each execution;
(c) repeating steps (a) and (b) for each of the candidate programs;
(d) receiving a plurality of bids for a plurality of the candidate programs, each bid defining a price for completing a desired number of program outputs in a desired amount of time;
(e) determining the amount of computing resources required to fulfill each of the bids based on the number of program outputs completed during each execution as measured in step (b);
(f) calculating a price per unit of time for the computing resources for each of the bids based on the price associated with the bid and the determined amount of computing resources required to fulfill each of the bids;
(g) fulfilling the bids based on the calculated price per unit of time for the computing resources, wherein the bids are fulfilled from highest to lowest until the available amount of computing resources is exhausted.

2. An automated method of determining price to execute a candidate program on a parallel computing system, the parallel computing system comprising a plurality of computing resources, wherein each of the computing resources has a price per unit of time, the method comprising:
(a) performing a plurality of executions of a candidate program, each execution being for a recorded amount of time and using different amounts of the computing resources;
(b) measuring number of work units completed during each execution; and
(c) defining pricing data for execution of the candidate program based on
(i) the measured number of work units completed during each execution,
(ii) the price per unit of time, and
(iii) the desired time to complete the desired number of work units, the pricing data defining prices for the parallel computing system to execute the candidate program to complete a desired number of work units in a desired amount of time.

3. The method of claim 2 further comprising:
(d) calculating customer prices to execute a candidate program based on a predefined markup to the pricing data.

4. The method of claim 2 wherein the recorded amount of time is an equal amount of time.
